(19) United States
(12) Patent Application Publication
(10) Pub. No.: US 2006/0254394 A1
(43) Pub. Date: Nov. 16, 2006

(54) Fastener driver

(75) Inventors: Nathan C. Cantlon, Charlo, MT (US); Jesse Croft, Ronan, MT (US); W. Robert Cornwell, Ronan, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Jore Corporation, Pasco, WA (US)

(21) Appl. No.: 11/125,840

(22) Filed: May 10, 2005

(51) Int. Cl. B25B 13/02

(52) U.S. Cl. 81/125

(57) ABSTRACT

A fastener driver (20) is provided. The fastener driver includes a driver body (32) and a guide (26). The driver body includes a cavity (30) formed in one end of the driver body and an attachment shank (32) formed in another end. The guide is slidably attached to the driver body and is positioned for selectively retaining a fastener within the cavity during use of the fastener driver.

### FIELD OF THE INVENTION

The described embodiments relate generally to hand tool accessories and, more particularly to a fastener driver having a fastener guide.

### BACKGROUND OF THE INVENTION

Currently available tool drivers include a shank having a driver head. The shank is configured to be coupled to a hand tool, such as a drill. The driver head is adapted to receive, but not retain, a fastener, such as a screw. During use, an operator must align and retain the fastener with a workpiece, such as a piece of wood, with one hand. It should be apparent that such a fastener presents significant risk of injury to the operator, especially during initial operation.

Thus, there exists a need for a fastener driver that is capable of retaining and/or guiding a fastener during use.

### SUMMARY OF THE INVENTION

A fastener driver constructed in accordance with one embodiment of the present invention includes a driver body and a guide. The driver body includes a cavity formed in one end of the driver body and an attachment shank formed in another end. The guide is slidably attached to the driver body and is positioned for selectively retaining a fastener within the cavity during use of the fastener driver.

A fastener driver constructed in accordance with another embodiment of the present invention includes a driver body, a sleeve coupled to the driver body, and means for retaining the sleeve to the driver body. The driver body includes a fastener receiving end and an attachment end. The sleeve is configured for reciprocating movement between an extended position, where the sleeve is adapted to substantially retain a fastener within the fastener receiving end, and a retracted position.

A fastener driver constructed in accordance with yet another embodiment of the present invention includes a driver body having a retention end and an attachment end, a guide, and a retention mechanism positioned between the driver body and the guide to retain the guide to the driver body. The attachment end of the driver body is configured for releasably coupling the fastener driver to a hand tool and the retention end is shaped to drive a correspondingly shaped end of a fastener. The guide is coupled to the driver body for reciprocating movement between an extended position for substantially retaining a fastener within the retention end and a retracted position.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isometric view of a fastener driver constructed in accordance with one embodiment of the present invention, showing a guide in an extended position;

FIG. 2 is an exploded view of the fastener driver of FIG. 1;

FIG. 3 is a cross-sectional, side planar view of the fastener driver of FIG. 1, showing the fastener driver in a retracted position; and

FIG. 4 is a cross-sectional, side planar view of the fastener driver of FIG. 1, showing the fastener driver in the extended position.

### DETAILED DESCRIPTION OF THE PREFERRED EMBODIMENT

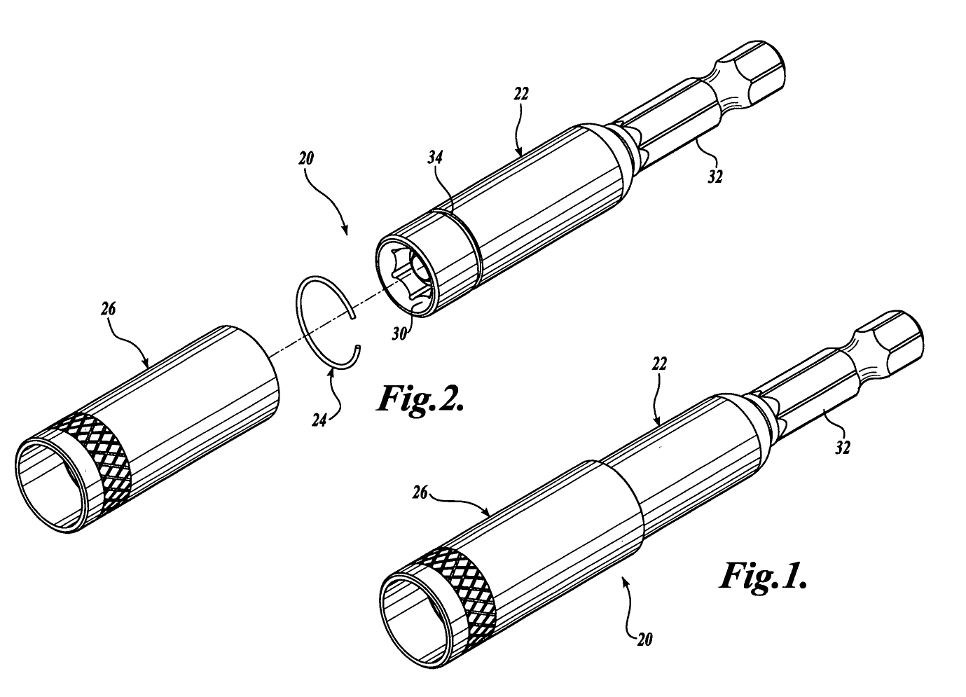

A fastener driver 20 constructed in accordance with one embodiment of the present invention may be best understood by referring to FIGS. 1 and 2. The fastener driver 20 includes a driver body 22, a retention mechanism 24, and a guide or sleeve 26. The driver body 22 is suitably a cylindrically shaped member formed from a high strength material. One end of the driver body 22 includes a cavity defining a fastener retention cavity 30.

The fastener retention cavity 30 is suitably hexagonal in configuration and is sized to fit a correspondingly configured end of a fastener, such as the head of a bolt. As already noted, although the fastener retention cavity 30 is illustrated and described as hexagonal, other shapes, such as spline, square and polygonal, are also within the scope of the present invention.

Still referring to FIGS. 1 and 2, the driver body 22 also includes an attachment shank 32. The attachment shank 32 is a well-known hexagonally shaped shank adapted to be coupled to a correspondingly shaped chuck of a hand tool, such as a power drill or a hand drill. Although the attachment shank 32 is illustrated as hexagonal, it need not be so limited as other well-known attachment shanks of varying sizes and shapes are also within the scope of the present invention.

The retention mechanism 24 is suitably a C-spring sized to be received within an annular groove 34 formed in the driver body 32. The function of the retention mechanism 24 is to retain the sleeve 26 to the driver body 22, as described in greater detail below. Equivalent structures having the same or equivalent function as the retention mechanism 24 include springs, e-clips and retention features built into the sleeve 26 and the driver body 22. Thus, such structures are equivalent and, therefore, are within the scope of the present invention.

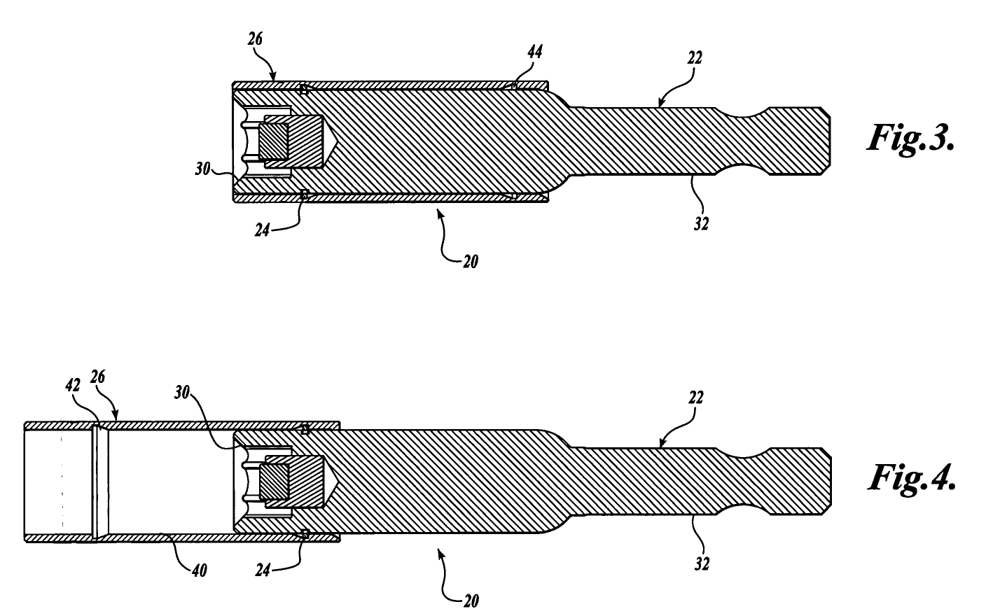

As may be best seen by referring to FIGS. 3 and 4, the sleeve 26 is suitably a cylindrical member having a longitudinally extending channel 40. The channel 40 is sized and configured to have an inner diameter slightly larger than an outer diameter of the driver body 22. This allows the sleeve 26 to be reciprocated by sliding relative to the driver body 22 between an extended position and a retracted position, as described in greater detail below.

The sleeve 26 also includes annular first and second retention grooves 42 and 44 formed within the channel 40. The first and second retention grooves 42 and 44 are longitudinally spaced to define a length of travel of the sleeve 26 during operation of the fastener driver 20. Each of the first and second retention grooves 42 and 44 are sized to lockingly receive the retention mechanism 24. The retention grooves 42 and 44 provide a tactile response when the retention mechanism 24 is received within one of the retention grooves 42 and 44. Each also provides a low level of locking resistance to hold the sleeve 26 therein. This locking resistance is overcome by the operator of the fastener driver 20 by applying a pushing or pulling action along an axis extending longitudinally through the fastener driver 20.

Operation of the fastener driver 20 may be best understood by referring to FIGS. 3 and 4. When the sleeve 26 is in the extended position (FIG. 4), a fastener (not shown) is received within both the cavity 40 and the fastener retention cavity 30. In this position, the sleeve 26 assists in retaining the fastener within the fastener retention cavity 30, as well as guiding the fastener during operation of the fastener driver 20. Specifically, the stem of the fastener is coaxially aligned with the cavity 40 and the head of the fastener is seated within the fastener retention cavity 30.

During use, the fastener is driven into a workpiece (not shown), such as wood, thereby causing the free end of the sleeve 26 contact the workpiece. As the operator continues to drive the fastener into the workpiece, the interaction between the workpiece and the sleeve 26 applies a load sufficient to overcome the locking resistance between the retention mechanism 24 and the first retention groove 42. As the fastener is driven into the workpiece, the sleeve 26 assists in retaining and guiding the fastener until it is firmly seated within the workpiece. In this position, the sleeve 26 is displaced into the retracted position, as shown in FIG. 3. The operator applies a load along the longitudinal axis of the sleeve 26 to displace the sleeve 26 into the extended position of FIG. 4 and the foregoing process is repeated.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A fastener driver for a hand tool, comprising:
(a) a driver body having a cavity formed in one end and an attachment shank formed in a second end, wherein the cavity is geometrically shaped to receive a correspondingly shaped end of a fastener; and
(b) a guide slidably attached to the driver body and positioned for selectively retaining a fastener within the cavity during use of the fastener driver, wherein the guide is positionable relative to the driver body between an extended position, wherein the guide substantially retains the fastener, and a retracted position.

2. The fastener driver of claim 1, wherein the attachment shank is adapted to be releasably coupled to a power tool.

3. A fastener driver for a hand tool, comprising:
(a) a driver body having a fastener receiving end and an attachment end;
(b) a sleeve coupled to the driver body for reciprocating movement between an extended position, where the sleeve is adapted to substantially retain a fastener within the fastener receiving end, and a retracted position; and
(c) means for retaining the sleeve to the driver body.

4. The fastener driver of claim 3, wherein the means for retaining the sleeve is a spring.

5. The fastener driver of claim 3, wherein the sleeve is displaced into the retracted position by engagement with a workpiece to cause the sleeve to slide along the driver body.

6. The fastener driver of claim 3, wherein the fastener receiving end is geometrically to received a correspondingly configured end of the fastener.

7. A fastener driver for a hand tool, comprising:
(a) a driver body having a retention end and an attachment end, the attachment end being configured for releasable coupling of the fastener driver to a hand tool and the retention end being shaped to drive a correspondingly shaped end of a fastener;
(b) a guide coupled to the driver body for reciprocating movement between an extended position for substantially retaining a fastener within the retention end and a retracted position; and
(c) a retention mechanism positioned between the driver body and the guide to retain the guide to the driver body.

8. The fastener driver of claim 7, wherein the guide is slidably coupled to the driver body and is displaced into the retracted position by engagement with a workpiece.
